(19) United States
(12) Patent Application Publication
(10) Pub. No.: US 2013/0082920 A1
(43) Pub. Date: Apr. 4, 2013

(54) CONTENT-DRIVEN INPUT APPARATUS AND METHOD FOR CONTROLLING ELECTRONIC DEVICES

(71) Applicants: Tun-Hao You, Taipei (TW); Yu-Chih Liu, Kaohsiung (TW); Yi-Jen Yeh, Miaoli (TW)

(72) Inventors: Tun-Hao You, Taipei (TW); Yu-Chih Liu, Kaohsiung (TW); Yi-Jen Yeh, Miaoli (TW)

(21) Appl. No.: 13/600,215

(22) Filed: Aug. 31, 2012

(30) Foreign Application Priority Data
Sep. 29, 2011 (TW) 100135280

(51) Int. Cl. G09G 5/00

(52) U.S. Cl. 345/156

(57) ABSTRACT

A content-driven apparatus for controlling electronic devices integrates all control command functions for at least one controlled electronic device. Content information transmitted from one of the controlled electronic devices is received by a communication module, and is passed to a processing element for parsing the content information, including types of the content information, desired command actions to be proceeded, controlled electronic devices required to cooperate, and how to operate for a user. The processing element decides a user interface and an operation method for the user after the parsing, and issues corresponding control messages to the controlled electronic devices required to cooperate after the user uses the operation method to select specific control commands.

### CROSS-REFERENCE TO RELATED APPLICATION

The present application is based on, and claims priority from, Taiwan Application No. 100135280, filed Sep. 29, 2011, the disclosure of which is hereby incorporated by reference herein in its entirety.

### TECHNICAL FIELD

The disclosure generally relates to a content-driven input apparatus and method for controlling electronic devices.

### BACKGROUND

With rapid development of embedded systems related technology (such as Android, MeeGo, etc.), a variety of high-end smart phones have emerged, and also drive electronic products having embedded systems with a variety of networking mechanisms, such as Wi-Fi, Bluetooth, etc., thus leads to powerful intelligent appliances producing more applications and services shaped into intelligent digital home environment. Currently, applications of intelligent electronic device mainly use network as a medium to convey instructions for remote controlling various electronic appliances; or through Internet access of the appliance, perform specific functions to obtain attached added value. Controlling of the traditional electronic device is operated through the user's knowledge based on provided functions. The television (TV), for example, control functions of which include channel switch, channel up and down, and volume adjustment, etc., for remote users selecting interested program and adjusting the volume. This type of control mode is limited to appliance-dependent command, has nothing to do with the content information of current broadcasting.

A technique is introduced by using motion sensor and touch panel as an input interface which is integrated into input apparatus of remote controller. And the remote control input is defined by a variety of gestures that were detected through motion sensors and touch panels. Another media event controlling technology provides corresponding control information by media information, allowing the input device proceeds related operation according to media information and corresponding control information, wherein control instruction signal is used to control the media information by sending signal to the existing carrier of media information.

There are several patent literatures provide technology related to operating control device/system of a number of other devices, also may include device for operating a number of other devices, this technology also provides method for communicating the control device with other devices, the control device/system has the ability to simultaneously operate multiple devices to achieve a certain situation. These technologies are mainly used for device control, and are not related to the content information of controlled devices.

For example, the technology disclosed in FIG.1 provides through a host device 102, hosting the state information of peripheral devices 110, and indicating on a display device 104 the input devices of the user's controlling device 100 and their corresponding information. After selecting controlled peripheral device from the controlling device 100, the host device 102 sends status information to the control device 100, so that the control device 100 is able to control the peripheral device 110. Another technique is the integration method of universal remote controller, wherein the controlled device may separately store operation information and user interface, the universal remote controller receives operation information to render the user interface for users to operate the controlled device, wherein the operation is limited to the device-dependent commands of the controlled devices, such as using remote controller to send play or stop command to a DVD player.

There is a Huddle system having auto-generated control interface to perform device control. The system connected to Huddle device transmits its function information to the input device, after the user sets connection among these devices on the input device, the input device will automatically generate a page of controllable control interface for all device connected to the system. This control interface is mainly used to process device-dependent commands of the devices connected to the system. In other words, the control interface is a group of device-dependent commands from individual device, and the controlled device is set by the user.

There is still much room for improvement in how to use the input device with the intelligent appliances. The example of Google TV is to re-create a new appearance of the remote controller with Logitech. However, the control function of intelligent appliance is often confined to the device-dependent control commands. When these intelligent appliances having the operating system, in addition to the original device-dependent control commands, further applications need to escape the original framework, for example, produce more extension functions, automatically change appropriate operating mode, the application context becomes smarter, and more close to human nature. Therefore, for the input device for controlling electronic device in the wave of intelligent appliances, how to integrate different content information and content-dependent control commands to produce more extension functions is more indispensable.

### SUMMARY

The exemplary embodiments of the present disclosure may provide a content-driven input apparatus and method for controlling electronic devices.

A disclosed embodiment relates to a content-driven input apparatus for controlling electronic devices. The apparatus may comprise an input unit, a communication module, a processing element, and a display device. In an initialization phase, the input device receives and integrates one or more device-dependent commands of each of one or more controlled electronic devices through the communication module. The communication module receives content information from each of the one or more controlled electronic devices, and sends to the processing element for parsing the content information, including types of the content information, desired command actions to be proceeded, controlled electronic devices required to cooperate, and how to operate for a user. The processing element, after parsing the content information and confirming one or more input device type contained in the input unit, decides a corresponding user interface displayed on the display device and a corresponding operation method. And after the user uses the operation method to select or proceed one selection of one or more control commands corresponding to the content information, the processing element issues one or more corresponding control messages to the controlled electronic devices required to cooperate through the communication module according to the one or more control commands corresponding to content information, to request each of the controlled electronics device required to cooperate to proceed corresponding actions according to the one or more corresponding control messages.

Another disclosed embodiment relates to a content-driven input method for controlling electronic devices. The method comprises: obtaining one or more device-dependent commands of each of one or more controlled electronic devices through an initialization action proceeded by a content-driven input device; when the content-driven input device receives content information from one of the one or more controlled electronic devices, parsing the content information and providing a corresponding user interface; and after receiving a selection selected or processed by one or more control commands corresponding to the content information, issuing one or more corresponding control messages to one or more controlled electronic devices required to cooperate.

The foregoing and other features of the exemplary embodiments will become easier understood from a careful reading of detailed description provided herein below with appropriate reference to the accompanying drawings.

### BRIEF DESCRIPTION OF THE DRAWINGS

FIG. 1 is a schematic view illustrating a controlling for interactive-type electronic devices.

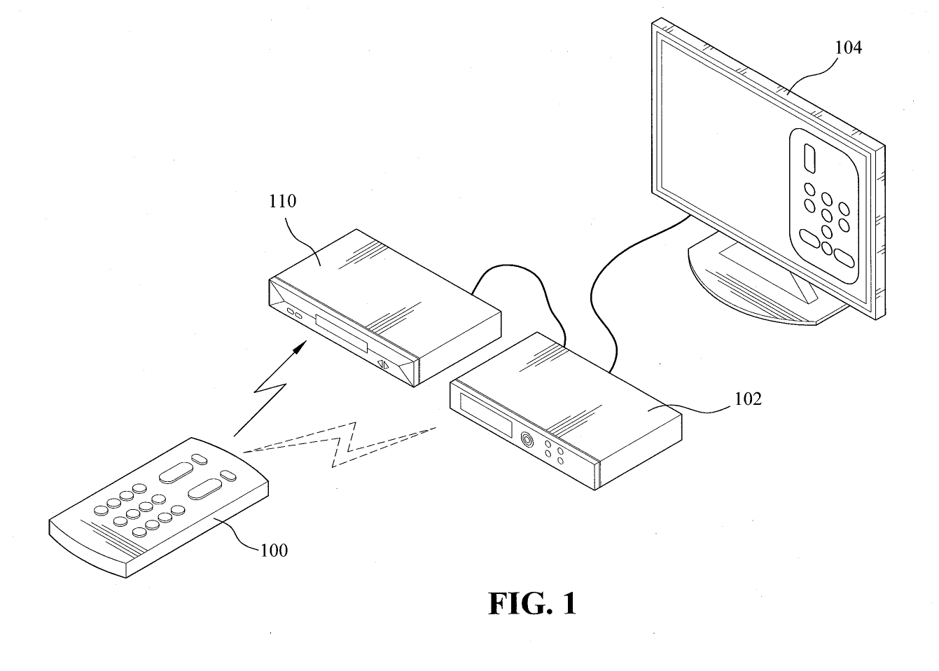

FIG. 2 is a schematic view illustrating an input apparatus for controlling electronic devices, according to an exemplary embodiment.

FIG. 3 is a block diagram illustrating the internal components of an input apparatus, according to an exemplary embodiment.

FIG. 4 is a block diagram illustrating the operation of a content-driven input apparatus for controlling electronic devices, according to an exemplary embodiment.

FIG. 5 is a schematic view illustrating at an initialization phase, all controlled electronic devices transmit their device-dependent command sets to a content-driven input apparatus, according to an exemplary embodiment.

FIGS. 6A-6B show examples of a markup language format transmitted from electronic devices to a remote input apparatus, according to an exemplary embodiment.

FIG. 7 shows an example of a format of content information transmitted from a host controlled device, according to an exemplary embodiment.

FIG. 8 is a schematic view illustrating a content-driven input apparatus, based on the received content information, provides a corresponding user interface, according to an exemplary embodiment.

FIG. 9 shows an example of sending control commands corresponding to the user's operation action described in FIG. 7 based on TV content information, according to an exemplary embodiment.

FIG. 10 is a schematic view illustrating the content information links with other related content information or services to produce extension functions, according to an exemplary embodiment.

FIG. 11 shows an operation flow of a content-driven input apparatus, according to an exemplary embodiment.

FIG. 12 is a schematic view illustrating a control phase, according to an exemplary embodiment.

### DETAILED DESCRIPTION OF DISCLOSED EXEMPLARY EMBODIMENTS

In the following detailed description, for purposes of explanation, numerous specific details are set forth in order to provide a thorough understanding of the disclosed exemplary embodiments. It will be apparent, however, that one or more exemplary embodiments may be practiced without these specific details. Well-known structures and devices are schematically shown for simplicity.

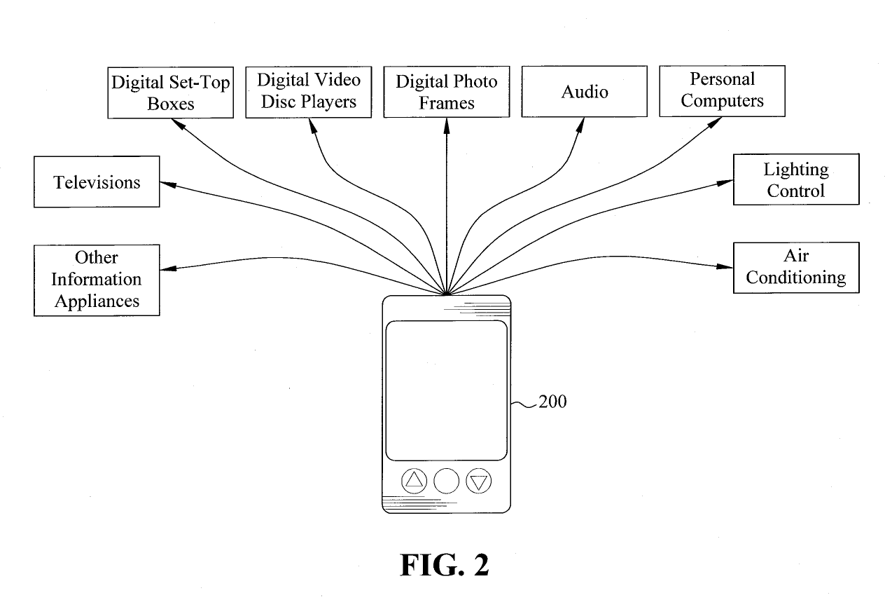

The disclosure presents a content-driven input apparatus for controlling electronic devices, such as shown in FIG. 2, an input apparatus 200. This can operate one or more electronic appliances according to the content information transmitted from controlled digital devices such as set-top boxes, video disc (DVD) players, photo frames, personal computers, televisions, and other information appliances, etc., as well as the corresponding control commands such as lighting control, air conditioning control, etc. The digital source automatically changes to an appropriate mode of operation according to the different content information of the controlled devices, thereby providing users with more intelligent functions of electronic devices, or allowing users to upload or download pre-defined control commands from at least one particular Internet source for specified electronic devices.

The input device 200 (see FIG. 2) is one of many design examples. When users watch TV, in addition to device-dependent commands of the TV set (for example, switch channels or change volume), the input device 200 may provide possible additional control commands. For example, when the TV playback content type is movie, the input device may provide additional control functions such as play, pause, fast forward, etc., and further uses may prompt different responses according to the content. In the case of a horror film, based on the broadcast content, the TV informs the input gadget (such as a remote control device) that since a horror film is now playing, consumers may decide whether the house should be prepared with a suitable atmosphere. Following on this information, the remote control device can give appropriate commands to various appliances, such as “turn darker” to lights, “pull up” to curtains, “raise volume” to the audio system, “cool down” to the air conditioning system.

In addition to the operation functions of electronic devices, another valuable feature is the content information stored in various appliances. In a TV, for example, in addition to the operation functions of switching channels, changing volume, and selecting radio stations, the stored content information is the most major utility for users, such as the name of the current TV program, video information, etc. Another example is the song title, lyricist name, composer name, or artist name, etc. of the audio that is playing.

The content information for a digital home may be integrated. Take radio as an example. In addition to pre-recording through a website or knowing each program information, much more may be done, such as playing program music at specific times, preparing a home atmosphere compatible with the contents of the music, and showing the music information on a computer. This is an application of a content information-oriented intelligent home.

The exemplary embodiments of a content-driven input apparatus for controlling electronic devices are designed as follows. After receiving content information from a controlled device, the input apparatus decides user interface, operation method and control commands. Afterwards a user uses a specified operation method to select at least one control command, thereby sending control messages to one or more controlled electronic devices required to cooperate with the host controlled electronic device. Then each related electronic device executes corresponding actions based on the request of the control messages

The content information for a digital home may be integrated. Take radio as an example. In addition to pre-recording through a website or knowing each program information, much more may be done, such as playing program music at specific times, preparing a home atmosphere compatible with the contents of the music, and showing the music information on a computer. This is an application of a content information-oriented intelligent home.

The exemplary embodiments of a content-driven input apparatus for controlling electronic devices are designed as follows. After receiving content information from a controlled device, the input apparatus decides user interface, operation method and control commands. Afterwards a user uses a specified operation method to select at least one control command, thereby sending control messages to one or more controlled electronic devices required to cooperate with the host controlled electronic device. Then each related electronic device executes corresponding actions based on the request of the control messages.

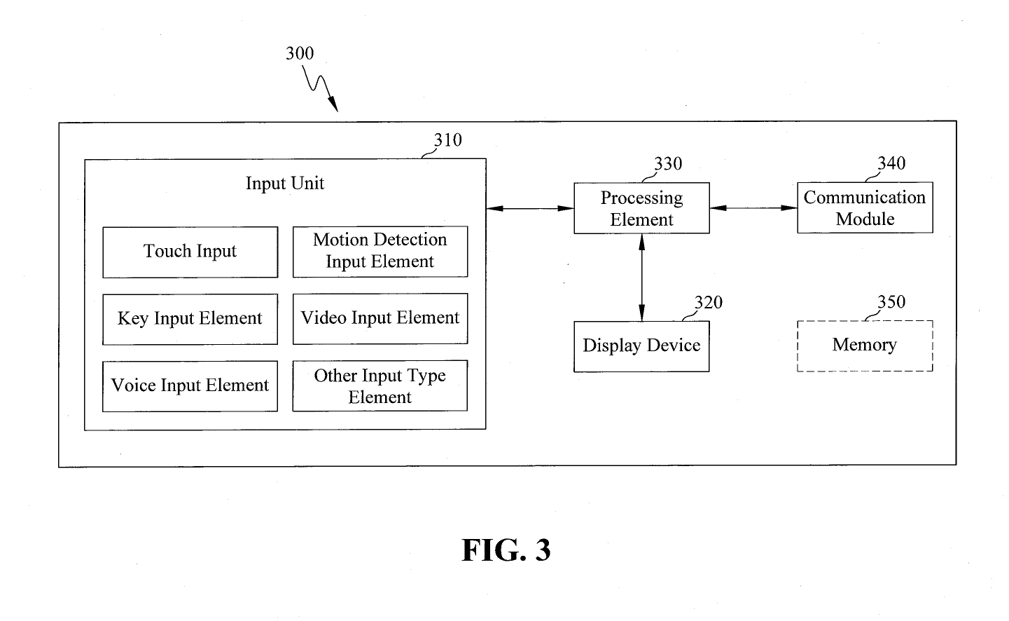

FIG. 3 is a block diagram illustrating the internal components of an input apparatus. As seen, a content-driven input apparatus 300 may include a processing element 330, an input unit 310, a communication module 340, and a display device 320. The communication module 340 is configured as the communication channel between the processing element 330 and controlled electronic devices. It receives content information from a controlled device, and sends one or more corresponding control messages specified by the processing element 330 to the one or more controlled electronic devices required to cooperate. The processing element 330 is configured to determine a corresponding user interface and display on the display device 320 and a corresponding operation method. It issues one or more specified corresponding control messages after receiving the input of unit 310.

As seen in FIG. 3, the input unit 310 may include any combination of one or more input device types of key input (such as physical buttons), touch input (such as touch panels), motion detection input (such as motion sensors), video input (such as cameras), voice input (such as microphones), and other input types. The content-driven input device 300 may further include a memory 350, which may be used to store one or more device-dependent commands of electronic devices after being integrated with the processing element 330.

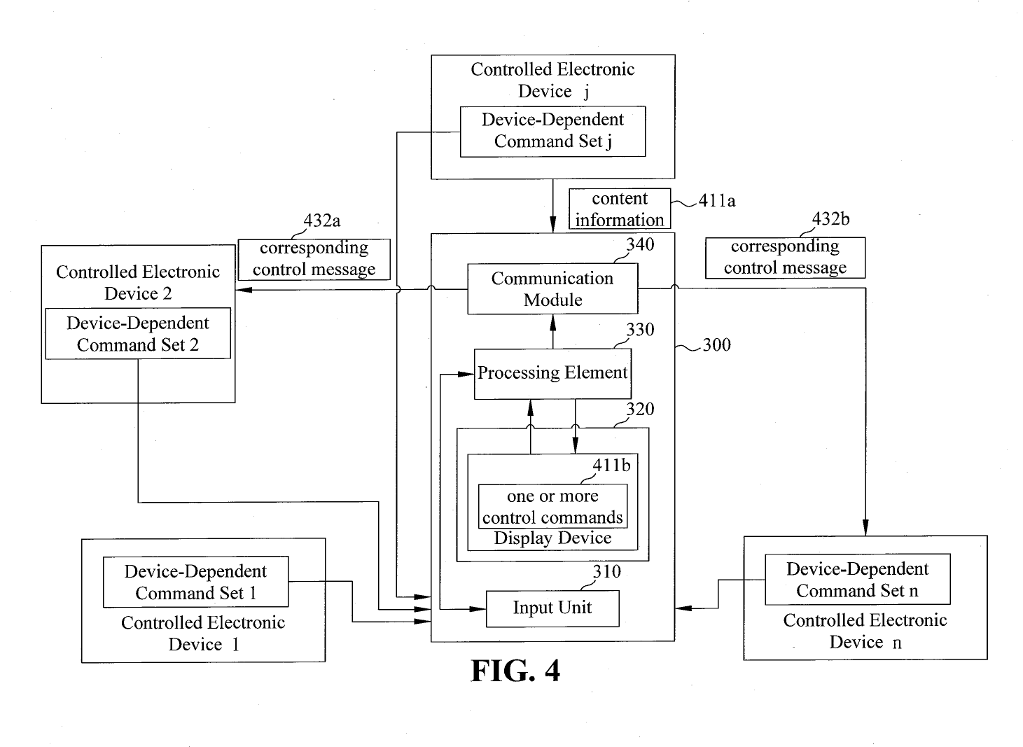

FIG. 4 is a block diagram illustrating the operation of a content-driven input apparatus for controlling electronic devices, according to an exemplary embodiment. Referring to FIG. 4, the content-driven input apparatus 300 for controlling electronic devices comprises of a display device 320, an input unit 310, a processing element 330, and a communication module 340. The content-driven input apparatus 300 starts with an initialization action. Each controlled electronic device i of n controlled electronic devices, where 1≦i≦n, sends its own device-dependent command set i to the content-driven input apparatus 300 through the communication module 340. Each device-dependent command set i contains one or more device-dependent commands. For example, lights, television, and other electronic devices may use markup language format and send their own device-dependent commands to the content-driven input apparatus 300. The content-driven input apparatus 300 integrates each device-dependent command set for the one or more controlled electronic devices. Then, the content-driven input apparatus 300 waits to see if it receives any content information from one of the controlled electronic devices.

Upon receiving content information 411a it transmits from one controlled electronic device j through the communication module 340, 1≦j≦n, to the processing element 330 for parsing the content information, including types of the content information 411a, desired command actions to be developed, controlled electronic devices required to cooperate, and how to be operated by a user, etc. The processing element 330, after parsing the content information 411a, decides a corresponding user interface and a corresponding operation method by referring to the input device type contained in the input unit 310, and displays this information on the display device 320. After the user uses the operation method to select one or more control commands 411b corresponding to the content information 411a, the processing element 330 sends one or more corresponding control messages, for example 432a and 432b, to the controlled electronic devices required to cooperate, for example the controlled electronic device 2 and the controlled electronic device n respectively, through the communication module 340. Each of the controlled electronic devices required to cooperate executes corresponding actions based on the request of the one or more corresponding control messages.

The controlled electronic device j is a host controlled device (host appliance) for transmitting the content information, and the one or more control commands 411b corresponding to the content information 411a may consist of device-dependent commands transmitted by the host controlled device and one or more subordinate controlled devices (subordinate appliances). In other words, communication module 340 acts as a communication channel between the processing element 330 and the host controlled device and the one or more subordinate controlled devices, for sending the content information and the one or more device-dependent commands from the host controlled device and the subordinate controlled devices to the processing element 330. It transfers the corresponding control commands of at least one content information specified by the processing element 330 into control messages which are then sent to the one or more controlled electronic devices required to cooperate. The processing element 330 determines the user operation method, based on the specified corresponding control messages, and the input device type contained in the input unit 310 after the processing element 330 receives and parses the content information. The user operation method may be determined by using the design of display device 320.

The processing element 330 may parse the content information, the one or more device-dependent commands corresponding to the content information, and the one or more specified control messages and the corresponding operation method, and display on the user interface of the display device 320 to indicate/inform the user how to operate the one or more device-dependent commands corresponding to the content information for the controlled electronic devices. Communication module 340, for example, can be any wired or wireless communication function module such as Ethernet, Wifi, RF, Irda, Bluetooth, Zigbee, etc.

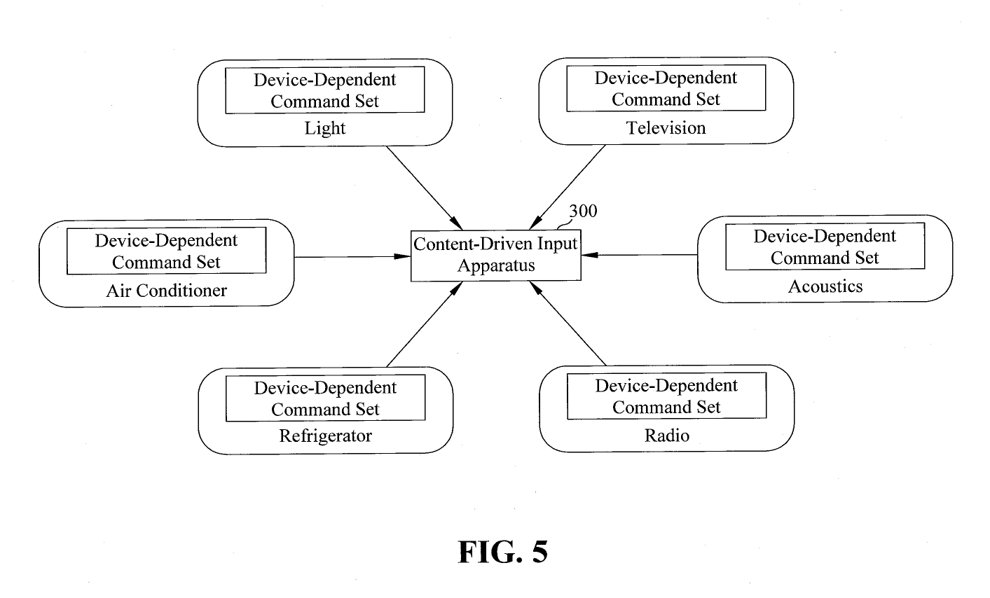

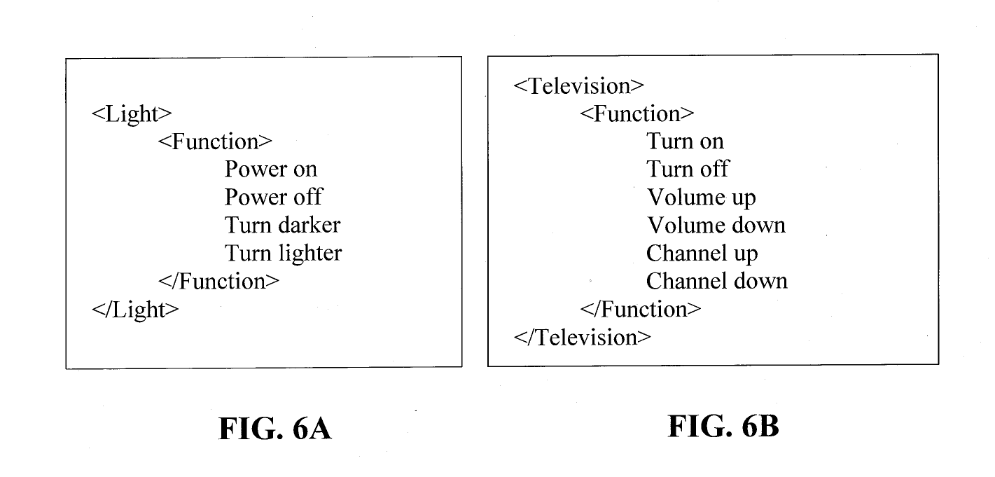

FIG. 5 is a schematic view illustrating the initialization phase. All controlled electronic devices transmit their device-dependent command sets to a content-driven input apparatus, according to an exemplary embodiment. As shown in FIG. 5, each of the electronic devices such as lights, televisions, air conditioners, refrigerators, radios, acoustics, etc., transmits its device-dependent command set to the processing element 330 of the content-driven input apparatus 300, and these device-dependent command sets are integrated by the processing component 330. FIGS. 6A-6B show examples of a markup language format transmitted from electronic devices to a remote input apparatus, according to an exemplary embodiment. The exemplary markup language shown in FIG. 6A illustrates a device-dependent command set of a light which may include device-dependent commands of power on, power off, turn darker, and turn lighter. The exemplary markup language shown in FIG. 6B illustrates a device-dependent command set of TV which may include commands of turn on, turn off, volume up, volume down, channel up, channel down, play, stop, and pause.

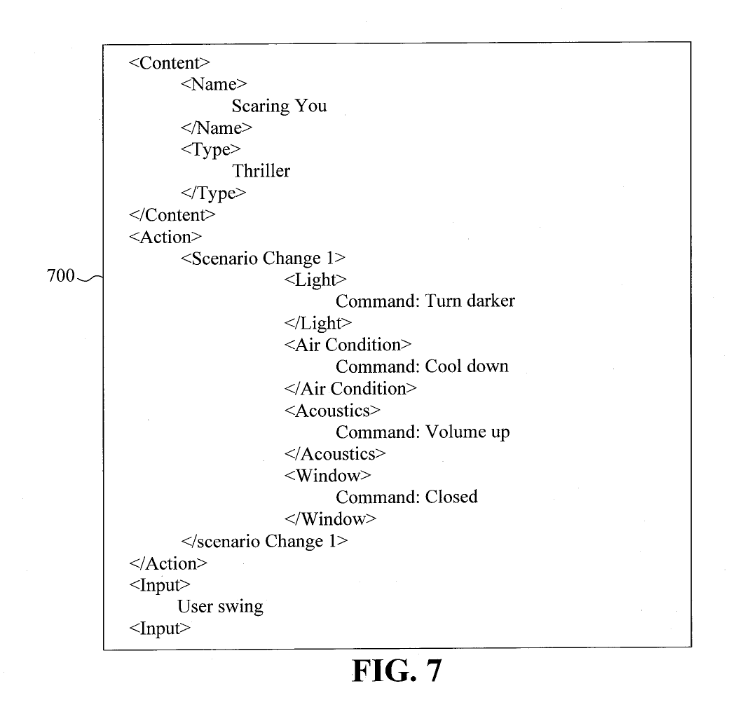

FIG. 7 shows a possible format of content information transmitted from a host controlled device, according to an exemplary embodiment. The exemplary content information 700 in FIG. 7 contains names and types of the content information, desired command actions to be performed, controlled electronic devices required to cooperate to achieve the desired actions, and the manual for user operation. In the example, the name of the content information is “Scaring You,” the type of the content information is “Thriller,” control commands corresponding to the content information is indicated by “Scenario Change,” controlled electronic devices required to cooperate include lights, air conditioning, audio, and window—the latter the user should operate “User swing.”

The content information of the exemplary embodiments is not limited to the example shown in FIG. 7. The content information of the exemplary embodiments may be relevant information provided by contents manufacturers (for example, show business) or service providers (such as television), or plug-in information or metadata written by a third party for different content types, such as an electronic program guide (EPG) designed for television channels, or scripts containing different situations, different ways of interaction (for example, questionnaires, etc.) for various different plots in a specific film. They can also be the control commands corresponding to the specific content information, allowing users to decide whether it should be used in smart appliances.

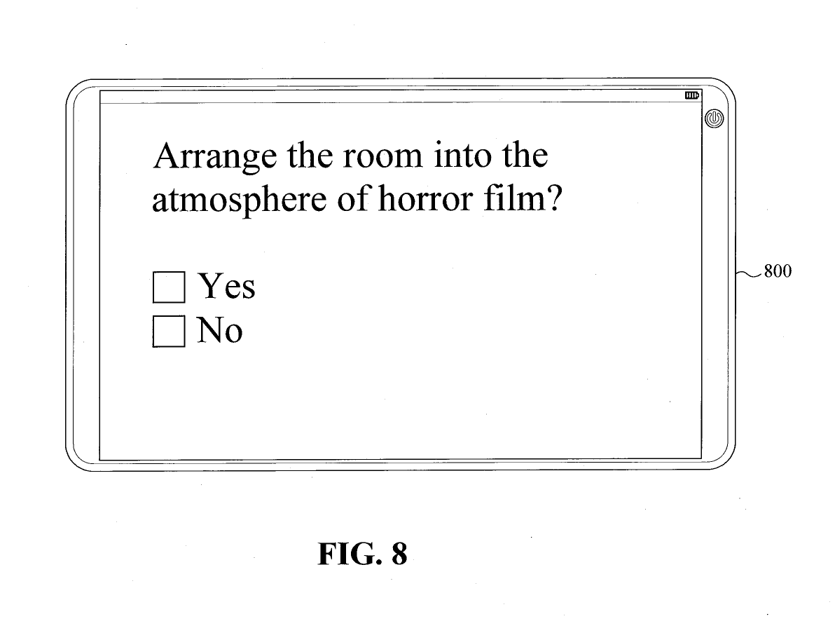

The user may see the message of the content information on content-driven input device 300, and may decide what to do according to suggestions. For example, as shown in FIG. 8, the processing element 330 of the content-driven input apparatus 300 provides a corresponding user interface 800 according to the received content information. Through the user interface 800, it may ask a user whether she/he wishes to prepare the room atmosphere to one suitable for a horror film. If the user decides to follow suggestions, the user may click “Yes” on the questionnaire of the user interface 800, and then may proceed to the relevant operation according to the control commands prompted by the user interface.

The user may see the message of the content information on content-driven input device 300, and may decide what to do according to suggestions. For example, as shown in FIG. 8, the processing element 330 of the content-driven input apparatus 300 provides a corresponding user interface 800 according to the received content information. Through the user interface 800, it may ask a user whether she/he wishes to prepare the room atmosphere to one suitable for a horror film. If the user decides to follow suggestions, the user may click “Yes” on the questionnaire of the user interface 800, and then may proceed to the relevant operation according to the control commands prompted by the user interface.

The content-driven input apparatus 300 may transfer the one or more control commands corresponding to the content information into a control message which is then sent out to each controlled electronic device. Because the content-driven input apparatus 300 in the initialization phase integrates the device-dependent command sets of all controlled electronic devices, knowing that there is no window control system in the application environments, it may skip windows operation. Each of the remaining controlled electronic devices receives a corresponding control message, and determines by itself whether further processing is needed. If it is required then actions are executed according to corresponding control commands of the above mentioned content information.

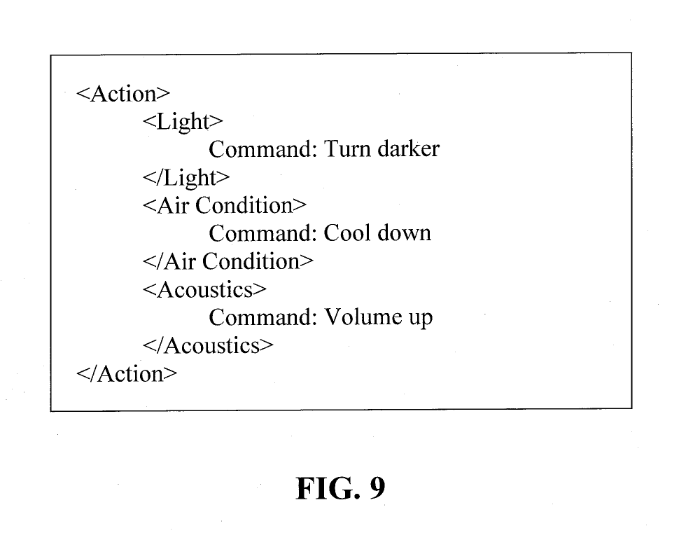

FIG. 9 shows an example of sending control commands corresponding to content information after the user clicks “Yes” in FIG. 8, according to an exemplary embodiment. Referring to FIG. 9, the one or more control commands corresponding to the content information that are sent out include turn darker (for light), cool down (for air conditioning), and volume up (for audio). These control commands may use XML format for processing, and the processing element 330 in the content-driven input apparatus 300 proceeds with the control operation of each controlled electronic device in accordance with the XML content. With enhanced processing power of embedded devices, the control commands corresponding to content information may also be determined by its own operations of each input device.

For example, after initialization of a mobile phone regarded as an input device, the mobile phone receives the information sent by the TV and processes by itself to decide which appliances need to be controlled. Thereafter it decides control commands corresponding to the content information and issues corresponding control messages to each controlled appliance. In FIG. 9, the control messages sent corresponding to the content information may not use XML format. The processing elements 330 in the content-driven input apparatus 300 may send corresponding control messages to each controlled electronic device through communication module 340, and the control messages may contain control commands corresponding to the content information.

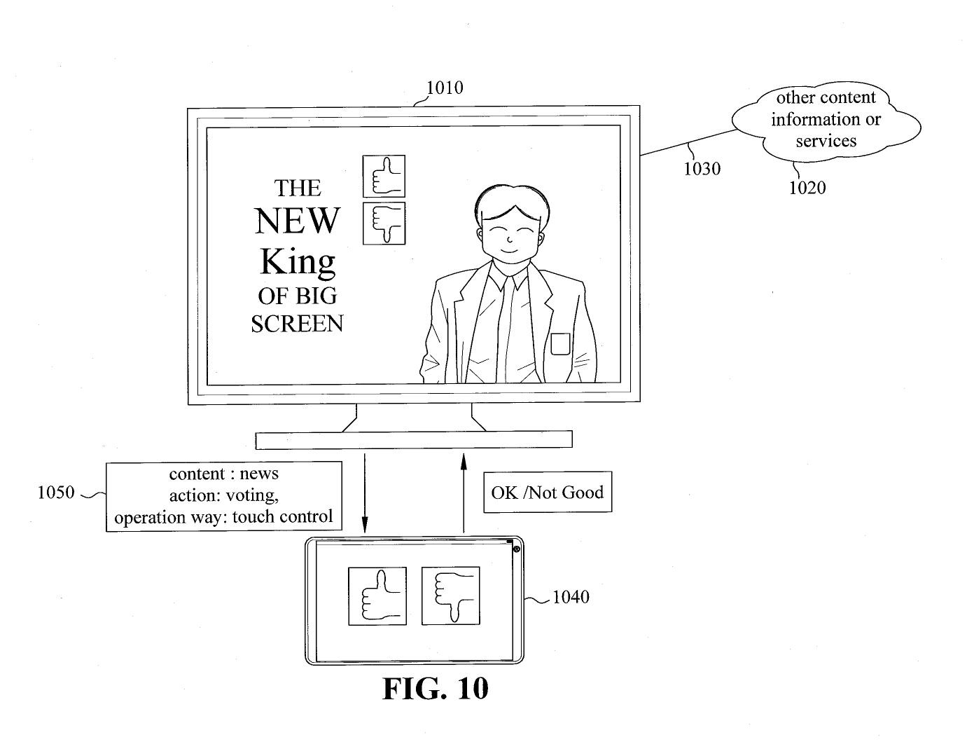

FIG. 10 is a schematic view illustrating the content information links with other related content information or services to produce extension functions, according to an exemplary embodiment. Referring to FIG. 10, a host controlled device (eg. TV 1010) transmits content information (such as news stories), and for example, via at least one Internet source 1030, links with other content information or services 1020. Users may use a mobile phone 1040 as a content-driven input apparatus. After initialization, the mobile phone 1040 receives the content information 1050 (including news content, desired voting action, and touch control operation) transmitted from the TV 1010. The user may, based on the news content transmitted from the controlled device 1010 showing on the display device, its linked content information or content service 1020 and corresponding control command (voting) corresponding to content information, proceed to online voting, such as by choosing OK or Not Good as response.

Accordingly, the exemplary embodiment of the content-driven input apparatus is based on the received content information, and refers to the input device type of the input unit 310 in the input apparatus 300, such as touch panel, motion detector, microphone, physical keys, etc., to provide different operation methods, so that the operation methods become more intuitive, may carry out multiple operations, integrate various controlled electronic devices, and have more situational applications. Also content formation may link with other content information or services to produce more extension functions. The content-driven input apparatus may simultaneously control multiple controlled electronic devices to meet the needs of the content information received.

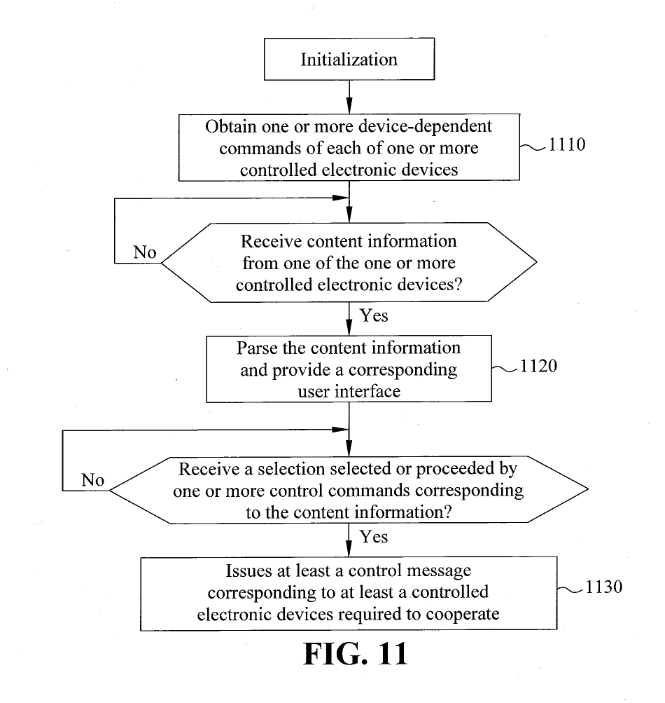

FIG. 11 further shows an operation flow for the content-driven input apparatus, according to an exemplary embodiment. The operation flow shown in FIG. 11 may include an initial phase and a control phase. In the initial phase, the content-driven input device executes initialization actions, and obtains one or more device-dependent commands of each of one or more controlled electronic devices, as shown in step 1110. Then, the content-driven input device waits to receive content information sent by one of the controlled electronic devices. When the content-driven input device receives the content information from one of the one or more controlled electronic devices, it enters the control phase, parses the content information and provides a corresponding user interface, as shown in step 1120. Then, the content-driven input device waits to receive a selection selected or proceeded by one or more control commands corresponding to the content information. When the content-driven input device receives the selection of the one or more control commands corresponding to the content information, it issues one or more control messages corresponding to the controlled electronic devices required to cooperate, as shown in step 1130. Each controlled electronic device required to cooperate executes corresponding actions based on the request of the one or more control messages, as mentioned above.

In the operation flow of FIG. 11, as mentioned earlier, the content information from electronic devices received by the content-driven input apparatus came primarily from a host controlled device, and the one or more control commands corresponding to the content information is any combination of device-dependent commands transmitted from the host controlled device and one or more subordinate controlled devices. In the control phase, through a communication module, the content-driven input apparatus may receive content information and device-dependent commands from the host controlled device and the one or more subordinate controlled devices, and issue one or more control messages corresponding to the controlled electronic devices required to cooperate.

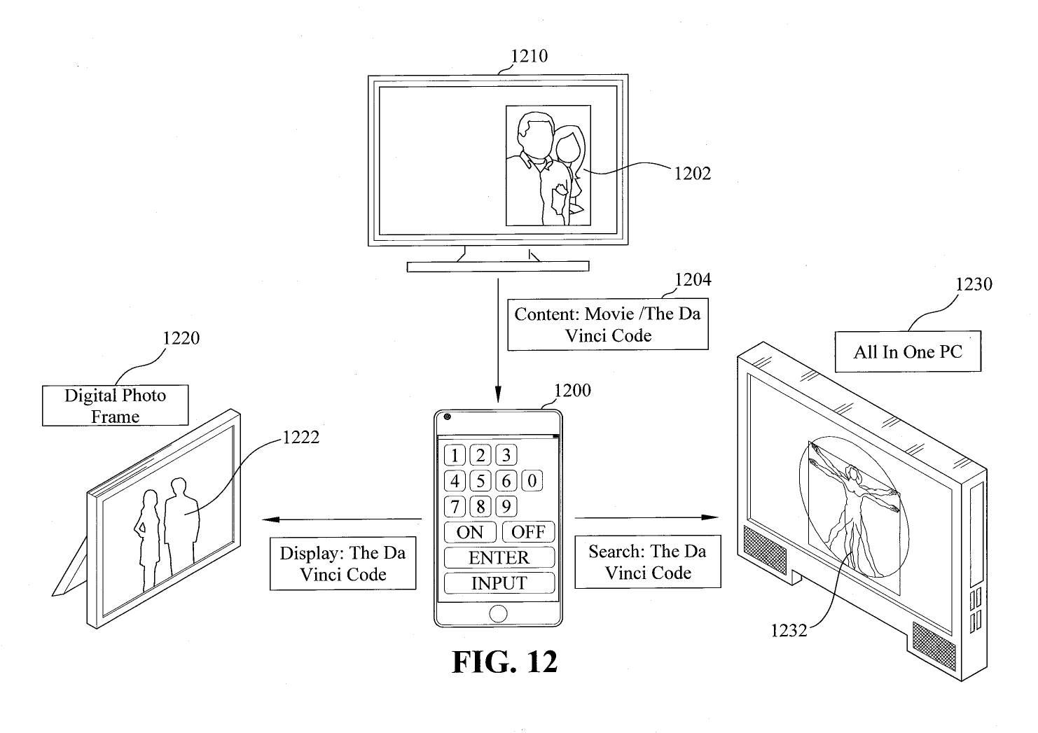

FIG. 12 is a schematic view illustrating a control phase, according to an exemplary embodiment. Referring to FIG. 12, suppose an electronic device (such as connected TV 1210) is playing a movie named The Da Vinci Code 1202. In the control phase, when the content-driven input apparatus (such as a mobile phone 1200) receives the content information from connected TV 1210, such as “content: Movie/The Da Vinci Code” 1204, the mobile phone 1200 parses the content information (Movie/The Da Vinci Code), and transmits the control messages corresponding to the controlled electronic devices required to cooperate, such as Digital Picture Frame 1220 and All-in-one PC (as known as AIO) 1230. In the example, this corresponding control message contains the control commands corresponding to the content information as in the initial phase mobile phone 1200 knows that the Digital Picture Frame 1220 has the function of showing pictures, and AIO 1230 has functions of search and image display. The Digital Picture Frame 1220, based on the control command “show” corresponding to content information, shows video image 1222 of the film The Da Vinci Code, and AIO 1230, based on the corresponding control command “Search” of the content information, searches a keyword “The Da Vinci Code” and displays its image 1232.

In summary, the disclosed exemplary embodiments provide a content-driven input technology for controlling electronic devices with the control commands corresponding to the content information and derived content information. The technique obtains one or more device-dependent commands of each of one or more controlled electronic devices via a content-driven input device. According to content information transmitted from a controlled electronic device, the technique parses the content information and determines a corresponding user interface, an operation method, control commands, and controlled electronic devices required to cooperate. After the user operates the selected control commands corresponding to the content information, one or more control messages are issued to the corresponding electronic devices required to cooperate. This content information oriented input technology may be applied by remote controller vendors (such as URC, Logitech), appliance manufacturers (such as Vizio, Samsung, SONY, Panasonic, LG), content information providers (such as Google, Yahoo, Microsoft), and so on.

It will be apparent to those skilled in the art that various modifications and variations can be made to the disclosed exemplary embodiments. It is intended that the specification and examples be considered as exemplary, with a true scope of the disclosure being indicated by following claims and their equivalents.

What is claimed is:

1. A content-driven input apparatus for controlling electronic devices, said apparatus receives and integrates one or more control commands of each of one or more controlled electronic devices at an initialization phase, comprising:
a display device;
an input unit;
a communication module for receiving content information transmitted from one of said one or more controlled electronic devices; and
a processing element for parsing the content information, including types of the content information, desired command actions to be proceeded, controlled electronic devices required to cooperate, and how to operate for a user;
wherein after parsing the content information and confirming one or more input device type contained in the input unit, said processing element, decides a corresponding user interface displayed on the display device and a corresponding operation method, and after executing the corresponding operation method to select or proceed one selection of one or more control commands corresponding to the content information, the processing element issues one or more corresponding control messages to the controlled electronic devices required to cooperate through the communication module according to the one or more control commands corresponding to content information, to request each of the controlled electronics devices required to cooperate to proceed corresponding actions according to the one or more corresponding control messages.

2. The apparatus as claimed in claim 1, wherein said input unit consists of any combination of input elements of at least one type as key input, touch input, motion detection input, video input and voice input.

3. The apparatus as claimed in claim 1, wherein said content information is content information transmitted form a host controlled device, and said one or more control commands corresponding to said content information consist of a plurality of device-dependent commands transmitted from said host controlled device and one or more subordinate controlled devices.

4. The apparatus as claimed in claim 1, wherein said processing element combines parsed content information, the one or more control commands corresponding to said content information and said operation method, and displays on said display device, to indicate or inform the user how to proceed an operation on the one or more control commands corresponding to said content information for said controlled electronic devices required to cooperate.

5. The apparatus as claimed in claim 1, wherein said content information is information provided by at least one content manufacturer or service provider, or plug-in information or metadata written by a third party for content of different types.

6. The apparatus as claimed in claim 3, wherein said communication module is configured as a communication channel between said processing element and said host controlled device and said one or more subordinate controlled devices, for passing said content information and said one or more device-dependent commands from said host controlled device and said one or more sub control devices to said processing element, and issues said one or more corresponding control messages to said controlled electronic devices required to cooperate.

7. The apparatus as claimed in claim 2, wherein said corresponding operation method is based on said content information received by said processing element, one or more specific control commands corresponding to said content information parsed by said processing element, and one or more input element types contained in said input unit, and determined by design of said display device.

8. A content-driven input method for controlling electronic devices, said method comprising:
obtaining one or more device-dependent commands of each of one or more controlled electronic devices through an initialization action proceeded by a content-driven input device;
when the content-driven input device receives content information from one of the one or more controlled electronic devices, parsing the content information and providing a corresponding user interface; and
after receiving a selection selected or processed by one or more control commands corresponding to the content information, issuing one or more corresponding control messages to one or more controlled electronic devices required to cooperate.

9. The content-driven input method as claimed in claim 8, wherein said content information received by said content-driven input device is content information transmitted from a host controlled device, and said one or more control commands corresponding to the content information consist of one or more device-dependent commands transmitted by said host controlled device and one or more subordinate controlled devices.

10. The content-driven input method as claimed in claim 8, wherein said method sends said content information comprising said one or more device-dependent commands from said host controlled device and said one or more subordinate controlled devices to said content—driven input device through a communication module, and issues said one or more control messages corresponding to said controlled electronic devices required to cooperate.

11. The content-driven input method as claimed in claim 8, wherein said method further comprising:
said content information, through at least one Internet, links with other content information or services to produce one or more extension functions.

12. The content-driven input method as claimed in claim 11, wherein said user selects or processes said selection on said one or more control commands corresponding to said content information, through said user interface.

13. The content-driven input method as claimed in claim 8, said method, after parsing said content information, determines a corresponding operation method to indicate or inform the user how to process an operation on the one or more control commands corresponding to said content information for said controlled electronic devices required to cooperate.

14. The content-driven input method as claimed in claim 10, wherein each controlled electronic device of said controlled electronic devices required to executes a corresponding action based on at least one request on said one or more corresponding control messages, after said controlled electronic devices required to cooperate receive said one or more corresponding control messages.

15. The content-driven input method as claimed in claim 14, wherein said content information is information provided by at least one content manufacturer or service provider, or plug-in information or metadata written by a third party.
